(19) United States
(12) Patent Application Publication
(10) Pub. No.: US 2024/0161351 A1
(43) Pub. Date: May 16, 2024

(54) System and Method for Augmented Reality Landscape Planning

(71) Applicant: Brett Poland, Jamestown, ND (US)

(72) Inventor: Brett Poland, Jamestown, ND (US)

(21) Appl. No.: 18/494,012

(22) Filed: Oct. 25, 2023

Related U.S. Application Data
(60) Provisional application No. 63/424,328, filed on Nov. 10, 2022.

(51) Int. Cl. G06T 11/00; G06Q 50/02

(52) U.S. Cl. CPC G06T 11/00; G06Q 50/02; G06T 2200/24

(57) ABSTRACT

A system and method for augmented reality landscape planning to capture an image of a specific area and a plurality of augmented reality algorithms residing on an augmented reality landscape planning non-transitory storage media to allow a user to apply prospective landscape designs on the captured image of the specific area. The captured image is captured by a camera disposed within the client device or from a satellite imagery from a Global Positioning System or GPS to provide an overhead view of the specific area. The overall system includes screenshots that include a home page screenshot, a create an account page screenshot, a new subscriptions screenshot, a log-in screenshot, a settings screenshot, a plant and location data screenshot, an augmented reality screenshot, a designer screenshot, a cellphone camera photo screenshot, a GPS photo screenshot, and a map photo screenshot displayed on the client device.

### CROSS-REFERENCE TO RELATED APPLICATIONS

This is a Non-Provisional patent application that claims the benefit of U.S. Provisional Patent Application No. 63/424,328 filed Nov. 10, 2022, which is incorporated herein by reference in its entirety.

### BACKGROUND OF THE INVENTION

### Technical Field

The present disclosure relates to a system and method, more particularly, to a system and method for augmented reality landscape planning.

### Prior Art

Landscaping is a popular means to decorate and individualize a home which presents a labor intensive and expensive process. However, landscaping may be difficult to visualize, as professional sketches are drawn to illustrate the proposed landscaping changes. Such sketches fail to properly capture the eventual appearance of the proposed landscaping changes, as various plants will grow, change colors through the seasons, or otherwise vary over time. Often, individuals are forced to begin landscaping the desired area without an ideal image of what the finalized design will look like. Should the landscaping be undesirable, an individual may be forced to reverse and restart the work. This may add undesirable delays and expense to the landscaping job. In order to address these concerns, a system and method for augmented reality landscape planning will provide users with an augmented reality overlay over a captured image of the desired area to plan various landscaping designs to minimize expense and optimize an eventual landscaping job.

Accordingly, a need remains to provide a system and method for augmented reality landscape planning to capture an image of a specific area and an augmented reality algorithm residing on an augmented reality landscape planning non-transitory storage media to allow a user to apply prospective landscape designs on the image of the specific area.

### BRIEF SUMMARY OF THE INVENTION

The present disclosure relations to relates to a system and method, more particularly, to a system and method for augmented reality landscape planning.

The system for augmented reality landscape planning includes a server system with a processor system, a communications interface, a communications system, an input system and an output system, the server system having access to a communications network, a memory system with an operating system, a communications module, a web browser module, a web server application and an augmented reality landscape planning non-transitory storage media, and a camera disposed on a client device that the augmented reality landscape planning non-transitory storage media is installed on.

The method for augmented reality landscape planning includes the steps of installing an augmented reality landscape planning non-transitory storage media on a client device, capturing an image of a specific area, and having the augmented reality landscape planning non-transitory storage media gain a perspective on how landscape choices will appear over time in different seasonal changes, wherein a plurality of augmented reality algorithms residing on an augmented reality landscape planning non-transitory storage media superimpose a plurality of prospective landscape designs on the image of the specific area in order to visualize potential landscaping options in the specific area.

There is a corresponding non-transitory computer storage media having instructions stored thereon which, when executed, execute the overall method that includes the steps of installing an augmented reality landscape planning non-transitory storage media on a client device, capturing an image of a specific area, and having the augmented reality landscape planning non-transitory storage media gain a perspective on how desired landscape choices will appear over time in different seasonal changes, wherein a plurality of augmented reality algorithms residing on an augmented reality landscape planning non-transitory storage media superimpose a plurality of prospective landscape designs on the image of the specific area in order to visualize potential landscaping options in the specific area.

It is an object of the present invention to provide a system and method for augmented reality landscape planning that properly captures the eventual appearance of the proposed landscaping changes that vary over time.

It is an object of the present invention to provide a system and method for augmented reality landscape planning that helps prevent a redo and restart of a landscape project.

It is an object of the present invention to provide a system and method for augmented reality landscape planning that provides users with an augmented reality overlay over a captured image of the desired area to plan various landscaping designs to minimize expense and optimize an eventual landscaping job.

### BRIEF DESCRIPTION OF THE DRAWINGS

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 illustrates a system overview of a system for augmented reality landscape planning, in accordance with one embodiment of the present invention.

FIG. 2A illustrates a block diagram of a client system, in accordance with one embodiment of the present invention.

FIG. 2B illustrates a block diagram of a server system, in accordance with one embodiment of the present invention.

FIG. 2C illustrates an additional system overview of a system for augmented reality landscape planning, in accordance with one embodiment of the present invention.

FIG. 3 illustrates a screenshot of a home page of the system for augmented reality landscape planning, in accordance with one embodiment of the present invention.

FIG. 4 illustrates a screenshot of a create an account page of the system for augmented reality landscape planning, in accordance with one embodiment of the present invention.

FIG. 5 illustrates a screenshot of a new subscriptions page of the system for augmented reality landscape planning, in accordance with one embodiment of the present invention.

FIG. 6 illustrates a screenshot of a log-in page of the system for augmented reality landscape planning, in accordance with one embodiment of the present invention.

FIG. 7 illustrates a screenshot of a settings page of the system for augmented reality landscape planning, in accordance with one embodiment of the present invention.

FIG. 8 illustrates a screenshot of a plant and location data page of the system for augmented reality landscape planning, in accordance with one embodiment of the present invention.

FIG. 9 illustrates a screenshot of an augmented reality page of the system for augmented reality landscape planning, in accordance with one embodiment of the present invention.

FIG. 10 illustrates a screenshot of a designer page of the system for augmented reality landscape planning, in accordance with one embodiment of the present invention.

FIG. 11 illustrates a screenshot of a cellphone camera photo of the system for augmented reality landscape planning, in accordance with one embodiment of the present invention.

FIG. 12 illustrates a screenshot of a GPS photo of the system for augmented reality landscape planning, in accordance with one embodiment of the present invention.

FIG. 13 illustrates a screenshot of a map photo of the system for augmented reality landscape planning, in accordance with one embodiment of the present invention.

FIG. 14 illustrates a flowchart for a method for augmented reality landscape planning, in accordance with one embodiment of the present invention.

### DETAILED DESCRIPTION OF THE INVENTION

The non-limiting exemplary embodiment(s) will now be described more fully hereinafter with reference to the accompanying drawings, in which a preferred embodiment of the disclosure is shown. Such exemplary embodiment(s) may, however, be embodied in many different forms and should not be construed as limited to the embodiment(s) set forth herein. Rather, these embodiment(s) are provided so that this application will be thorough and complete, and will fully convey the true scope of the disclosure to those skilled in the art.

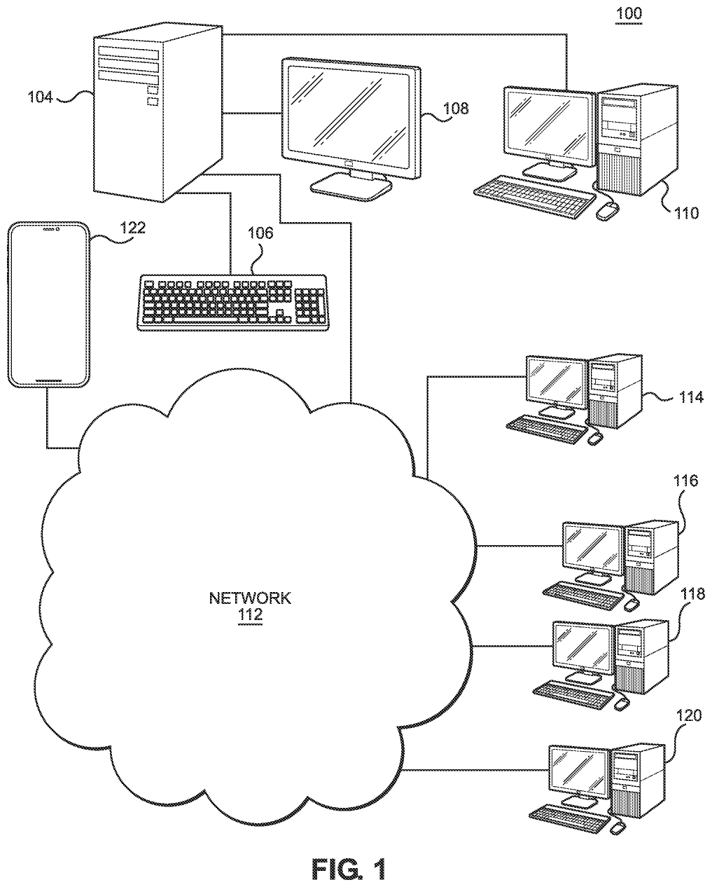

FIG. 1 illustrates a system overview of a system for augmented reality landscape planning 100, in accordance with one embodiment of the present invention.

The overall system 100 includes a server system 104, an input system 106, an output system 108, a plurality of client systems 110, 114, 116, 118 and 120, a communications network 112 and a hand-held device 122. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

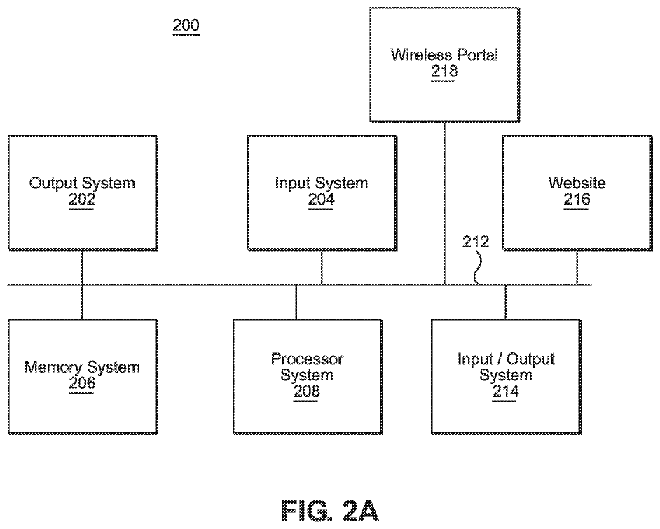

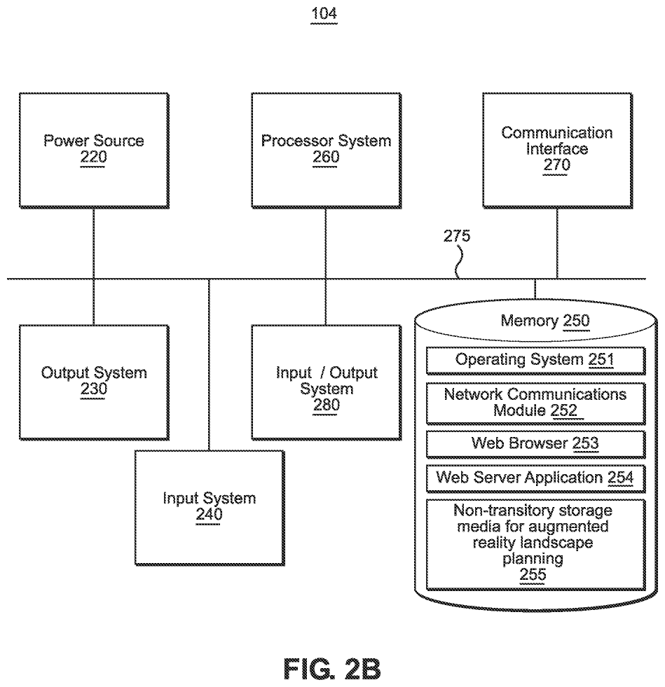

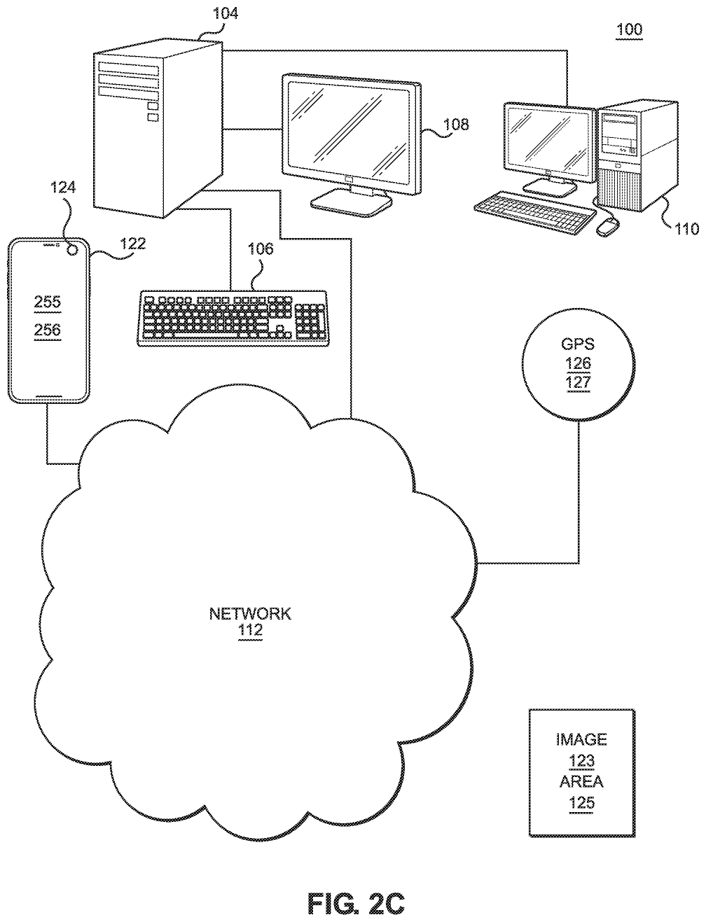

FIG. 2A illustrates a block diagram of a client system 200 that may be used as one of the system units for augmented reality landscape planning, in accordance with one embodiment of the present invention.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine readable machine-readable mediums that may store a variety of different types of information. The term machine readable machine-readable medium is used to refer to any medium that is structurally configured for carrying information in a format that is readable by a machine. One example of a machine-readable medium is a computer-readable medium. The memory system 206 also stores a non-transitory storage media for augmented reality landscape planning (FIG. 2B, 255).

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218, which is also tied directly into the communications system 212. Any website 216 or wireless portal 218 would also include software and a website module (no number) to maintain, allow access to and run the website as well.

FIG. 2B illustrates a block diagram of a server system 104 that may be used for augmented reality landscape planning, in accordance with one embodiment of the present invention.

The server system 104 may include a power source 220, an output system 230, an input system 240, a memory system 250, which may store an operating system 251, a communications module 252, a web browser module 253, a web server application 254, and a non-transitory storage media for augmented reality landscape planning 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine readable machine-readable mediums that may store a variety of different types of information. The term machine readable machine-readable medium is used to refer to any medium capable of carrying information that is readable by a machine. One example of a machine-readable medium is a computer-readable medium. The memory system 250 may store one or more machine instructions for augmented reality landscape planning. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves and the like.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240. The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

FIG. 2C illustrates a system overview of a system for augmented reality landscape planning 100, in accordance with one embodiment of the present invention.

The augmented reality landscape planning non-transitory storage media (FIG. 2B, 255) may be installed on the client device (FIG. 1, 122). In real time, the client device 122 will capture an image 123 of a specific area 125. The captured image 123 may be captured by a camera 124 disposed within the client device 122 or from a satellite imagery 127 from a Global Positioning System or GPS 126 to provide an overhead view of the specific area 125.

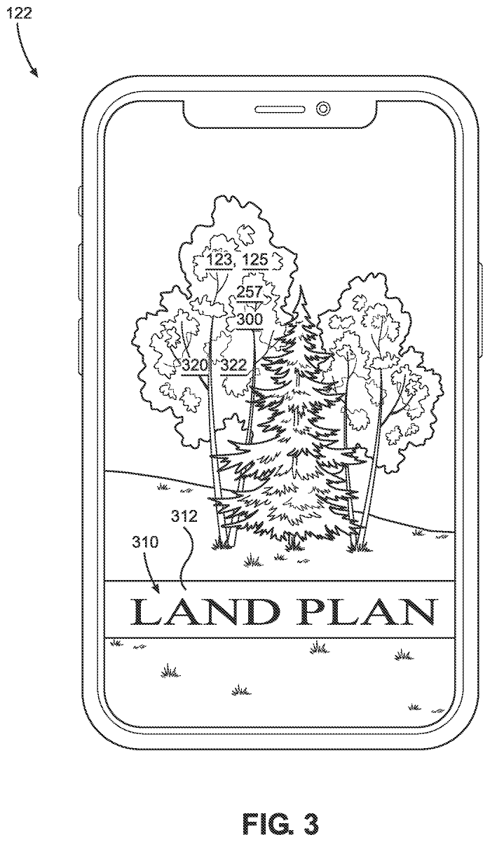

FIG. 3 illustrates a screenshot of a home page 300 of the system for augmented reality landscape planning 100, in accordance with one embodiment of the present invention.

A plurality of augmented reality algorithms (FIG. 2C, 256) residing on an augmented reality landscape planning non-transitory storage media (FIG. 2B, 255) may allow the user to superimpose a plurality of prospective landscape designs 257 on the image (FIG. 3, 123) of the specific area (FIG. 3, 125) in order to visualize potential landscaping options in the specific area 125. The user will be allowed to place, remove, or alter landscape structures anywhere in the specific area 125 before performing any actual work on the specific area 125. The augmented reality algorithms 256 will further allow for the user to gain a perspective on how their desired landscape choices will appear over time in different seasonal changes and may provide a cost analysis of a landscape process.

For example, a user may place one or more images of various plants, whereupon the user may then advance the time of the superimposed image to see how the various plants grow and change in various seasons. As such, a user may avoid overcrowding as plants grow, and ensure that any colors present during various seasons are complementary in advance of engaging in the proposed landscaping.

The home page 300 may include a company moniker 310 and a landscaping background 320.

The company moniker 310 may be a Land Plan moniker 312 or the like. The landscaping background 320 may be a tree in a field 322 or the like.

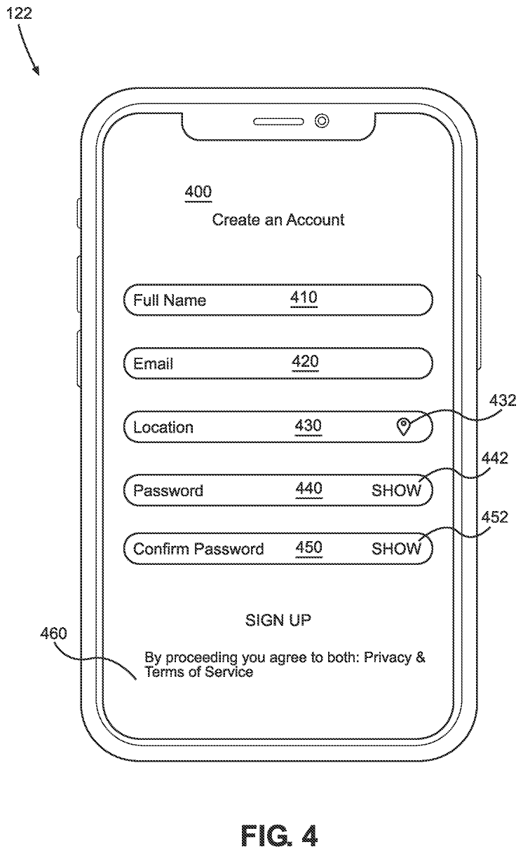

FIG. 4 illustrates a screenshot of a create an account page 400 of the system for augmented reality landscape planning 100, in accordance with one embodiment of the present invention.

The create an account page 400 may include a digital full-name field 410, a digital email field 420, a digital location field 430, a digital password field 440, and a digital confirm password field 450.

The digital full-name field 410 may be the first, last, and middle name of the user. The digital email field 420 may be the email address of the user. The digital location field 430 may include the location of the user. This may include the location of the user on a map shown at the blue reference point 432. The digital password field 440 may include a Show link 442 that shows the password being entered. The digital confirm password field 450 may include confirmation of the password entered in the digital password field 440. The digital confirm password field 450 may include a Show link 452 that shows the password being entered.

There is also a disclaimer 460 that states that by proceeding, the user agrees to the privacy policy and the terms of service.

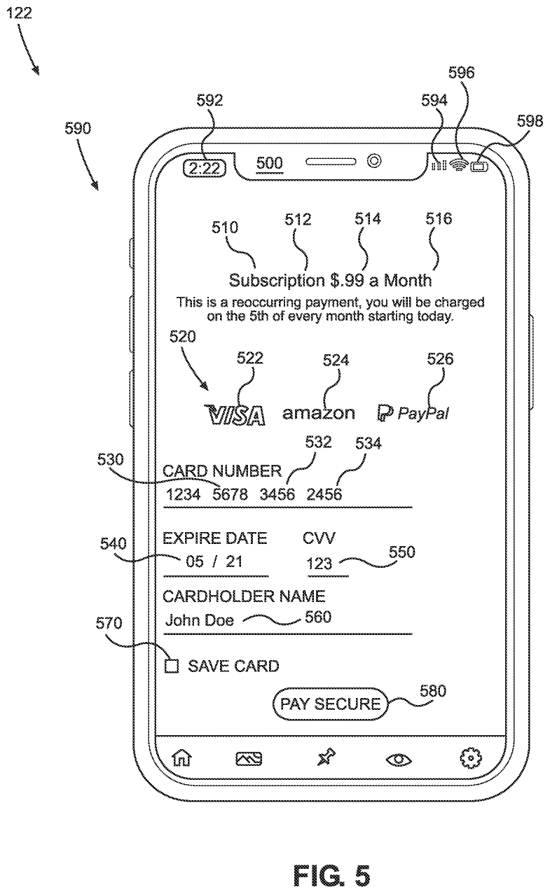

FIG. 5 illustrates a screenshot of a new subscriptions page 500 of the system for augmented reality landscape planning 100, in accordance with one embodiment of the present invention.

The new subscriptions page 500 may include a subscription description 510, a plurality of payment methods 520, a digital card number field 530, a digital expiration number field 540, a Card Verification Value or CVV field 550, a Cardholder name field 560, a Save Card checkbox 570, a Pay Secure button 580, and a plurality of mobile phone indicia 590.

The subscription description 510 may include a subscription price 512, confirmation that there is a reoccurring payment for the subscription 514, and what day of the month the monthly subscription price will be charged 516. The payment methods 520 may include a VISA card 522, an Amazon credit card 524, a PayPal account charge 526, or the like. The digital card number field 530 may be for a credit card 532 and a debit card 534 or the like. The digital expiration number field 540 may be for the expiration date of the credit card 532 or the debit card 534. The CVV field 550 may be from the credit card 532 and the debit card 534 and is used as an extra security provision. The Cardholder name field 560 may be the cardholder's name as it appears on the credit card 532 and the debit card 534. The Save Card checkbox 570 may be filled-in and checked or unchecked with a cursor (not shown) to indicate if the credit card 532 or the debit card 534 is saved. The Pay Secure button 580 may be depressed to finalize a subscription payment from the credit card 532 or the debit card 534. The mobile phone indicia 590 may include a digital time display 592, an Internet signal indicia 594, an Internet signal strength indicia 596, and a battery strength indicia 598.

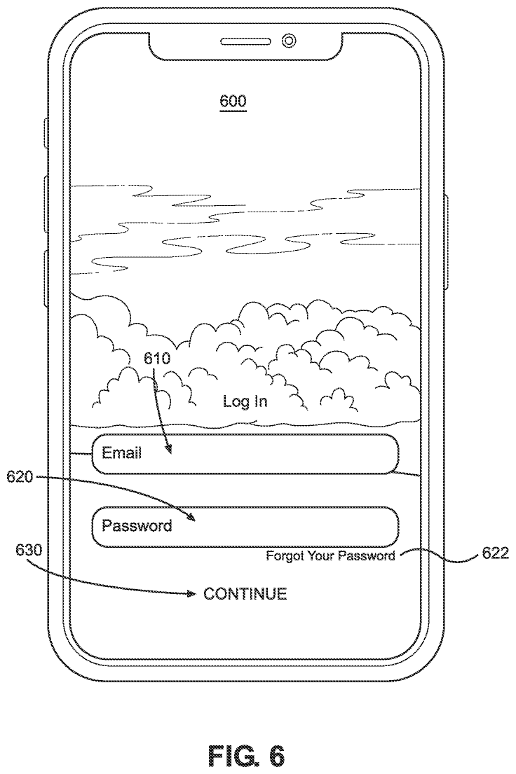

FIG. 6 illustrates a screenshot of a log-in page 600 of the system for augmented reality landscape planning 100, in accordance with one embodiment of the present invention.

The log-in page 600 may include an email address field 610, a password field 620, and a digital Continue link 630.

The email address field 610 may be the email address of a user or the like. The password field 620 may be predetermined from the user and includes a forgot your password link 622. The digital Continue link 630 may be depressed after the email address field 610 and the password field 620 have been filled.

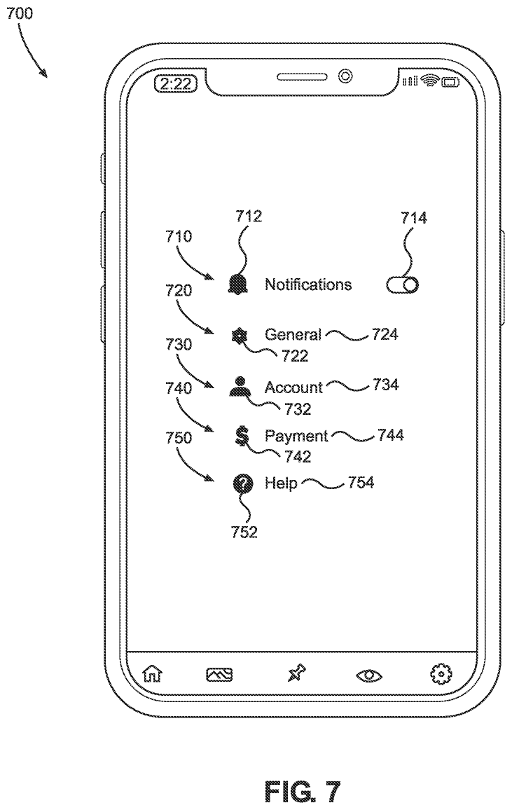

FIG. 7 illustrates a screenshot of a settings page 700 of the system for augmented reality landscape planning 100, in accordance with one embodiment of the present invention.

The settings page 700 may include a Notifications button 710, a General settings link 720, an Account setting link 730, a Payment link 740, and a Help link 750.

The Notifications button 710 may include a bell-shaped indicia 712 and a toggle button 714 to turn a plurality of notifications on and off. The General settings link 720 may include a cog-shaped indicia 722 and may be activated to disclose a plurality of General settings information 724. The Account setting link 730 may include a Human indicia 732 and may be activated to disclose a plurality of Account setting information 734. The Payment link 740 and may be activated to disclose a “$” indicia 742 and a plurality of payment information 744. The Help link 750 may include a “?” inside of a circle indicia 752 and may be activated to disclose a plurality of help information 754.

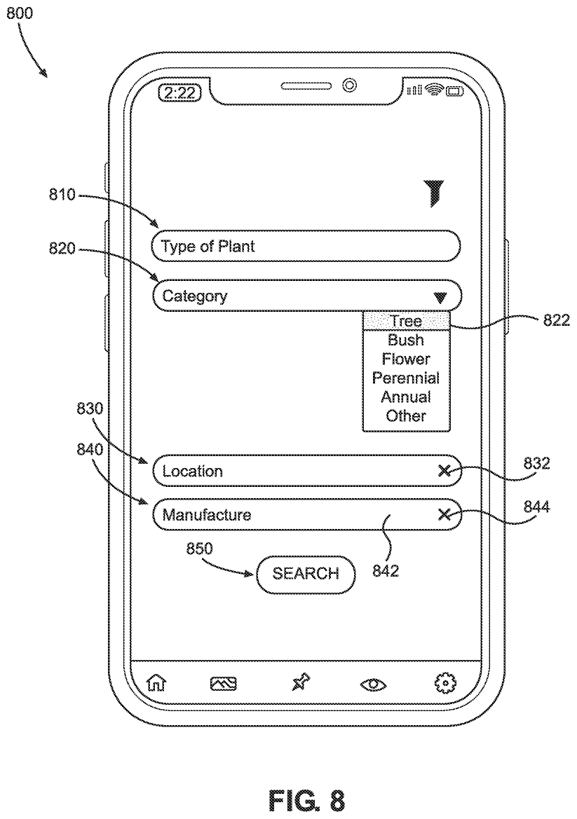

FIG. 8 illustrates a screenshot of a plant and location data page 800 of the system for augmented reality landscape planning 100, in accordance with one embodiment of the present invention.

The plant and location data page 800 may include a type of plant field 810, a category dropdown menu 820, a location field 830, a manufacture field 840, and a search button 850.

The type of plant field 810 may be any type of plant entered in the type of plant field 810. The category dropdown menu 820 may include a plurality of plant categories 822 selected from the group consisting of a bush, a flower, a perennial, an annual, or other. The location field 830 may receive a location address or the like and have an “x” that may be clicked on to clear the location field 830. The manufacture field 840 may receive a manufacturer's name 842 or the like and have an “x” that may be clicked on to clear the manufacture field 840. The search button 850 may be depressed to perform a search with the type of plant field 810, the category dropdown menu 820, the location field 830, and the manufacture field 840.

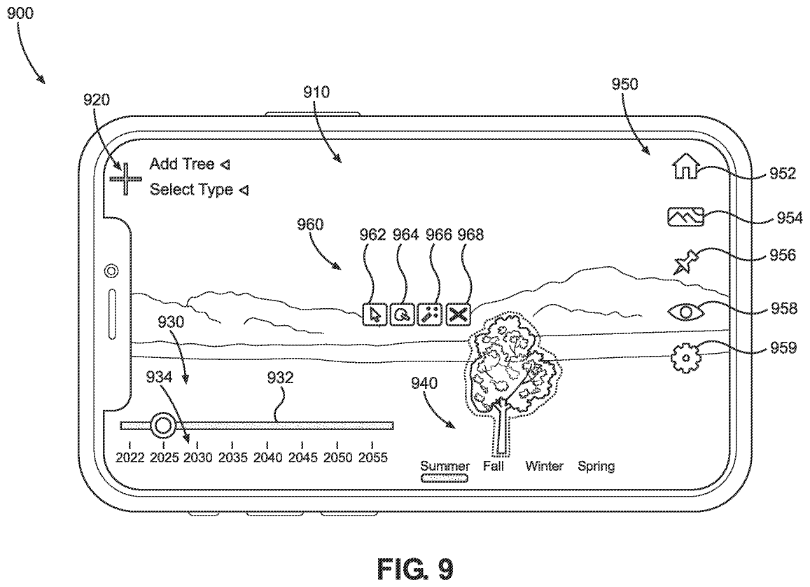

FIG. 9 illustrates a screenshot of an augmented reality page 900 of the system for augmented reality landscape planning 100, in accordance with one embodiment of the present invention.

The augmented reality page 900 may include an augmented reality background 910, a cross-hair 920, a year timeline 930, a plurality of seasons 940, a plurality of supplemental indicia 950, a plurality of augmented reality tools 960, and a plurality of type of plant fields (FIG. 8, 810).

The augmented reality background 910 may be disposed on the first augmented reality page 900. The cross-hair 920 may be moved to place an object on the augmented reality background 910. The year time line 930 may include a side bar 932 that may be moved to correspond to a calendar year 934. The seasons 940 may be selected from the group consisting of Summer, Winter, Spring, and Fall or the like. The supplemental indicia 950 may include a plurality of home information 952, a plurality of background information 954, a plurality of thumbtack information 956, a plurality of hidden information 958 such as a password or the like and a plurality of settings 959. The augmented reality tools 960 may include a diagonal arrow indicia 962 that may be clicked for transferring information, a held pen 964 that may be used to write on the first augmented reality page 900, a written review icon 966 that may be utilized to write a review and rate with a plurality of stars or the like, and a collaboration icon 968 that allows sharing of content for editing or the like.

The type of plant fields 810 were previously illustrated in FIG. 8 and are described in its description FIG. 8.

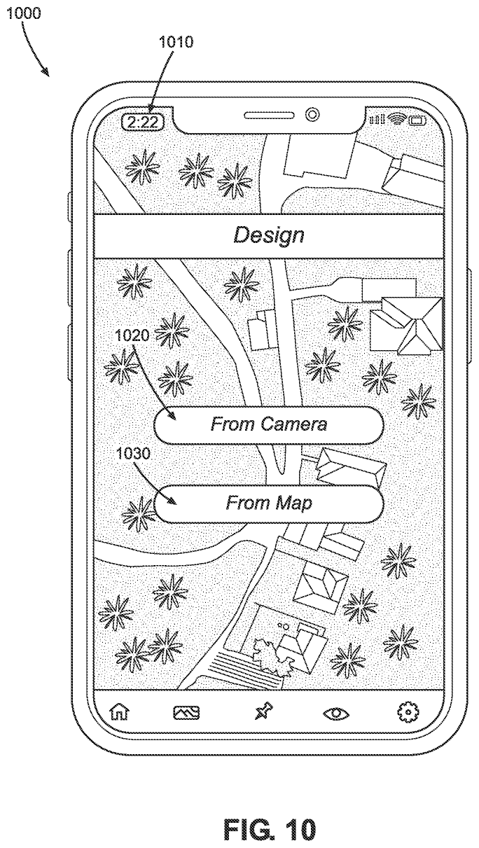

FIG. 10 illustrates a screenshot of a designer page 1000 of the system for augmented reality landscape planning 100, in accordance with one embodiment of the present invention.

The designer page 1000 may include a background 1010, a From Camera button 1020, and a From Map button 1030.

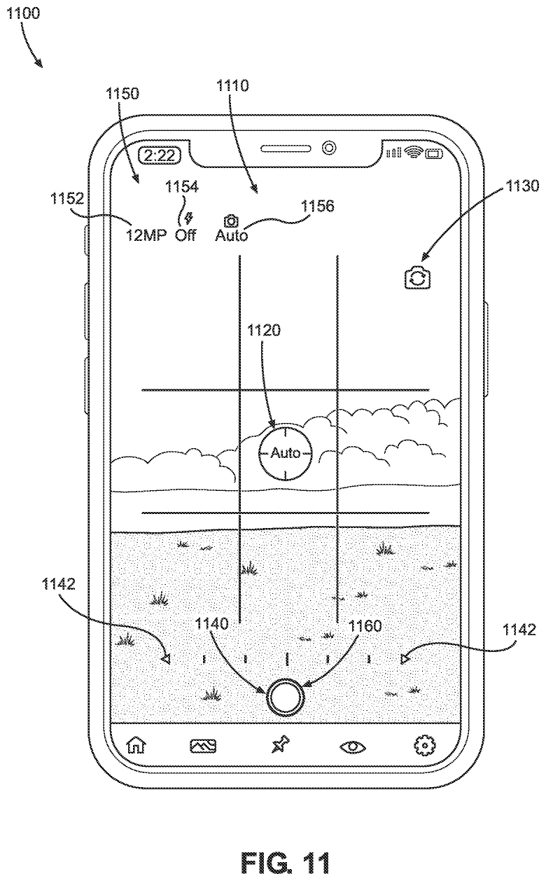

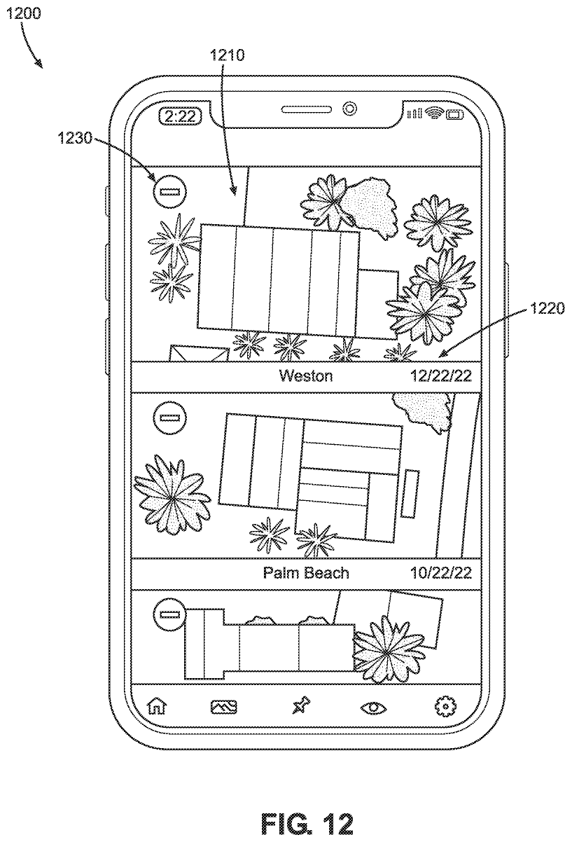

The background 1010 may be a photo from a camera (FIG. 2C, 124) of a cellphone (FIG. 2C, 122) or a GPS (FIG. 2C, 126) or the like. The From Camera button 1020 may be activated to take the photo from a camera 124 of a cellphone 122, which is described further in FIG. 11 and its description. The From Map button 1030 may be activated to take the photo from a GPS 126 or the like, which is described further in FIG. 12 and its description.

FIG. 11 illustrates a screenshot of a cellphone camera photo 1100 of the system for augmented reality landscape planning 100, in accordance with one embodiment of the present invention.

The cellphone camera photo 1100 may include a 9-section grid 1110, an auto focus scope 1120, a digital camera icon 1130, a horizontal directional grid 1140, a plurality of digital photo indicia 1150, and a photo activation button 1160.

The 9-section grid 1110 may be added onto the augmented reality background (FIG. 9, 910). The auto focus scope 1120 may allow for a focused placement or photo of an area disposed on the 9-section grid 1110. The digital camera icon 1130 may be activated to utilize the camera (FIG. 2C, 124) disposed within the client device (FIG. 2C, 122). The horizontal directional grid 1140 may include an arrow 1142 disposed on each end of the horizontal directional grid 1140 to allow movement of the 9-section grid 1110. The digital photo indicia 1150 may include a pixel reading indicia 1152 to indicate the current pixel level, an off indicia 1154 to indicate when the camera is off, and an auto indicia 1156 that indicates when the auto feature of the camera is activated. The photo activation button 1160 may be activated to take a desired photo for use of the augmented reality background (FIG. 9, 910).

FIG. 12 illustrates a screenshot of a GPS photo 1200 of the system for augmented reality landscape planning 100, in accordance with one embodiment of the present invention. More specifically, FIG. 12 illustrates 3 GPS photos 1200.

The GPS photo 1200 may include a base snapshot 1210, a location and date stamp 1220 of when the GPS photo was taken, and an “-” indicia 1230 that may be activated to delete the GPS photo 1200 corresponding to the respective GPS photo 1200.

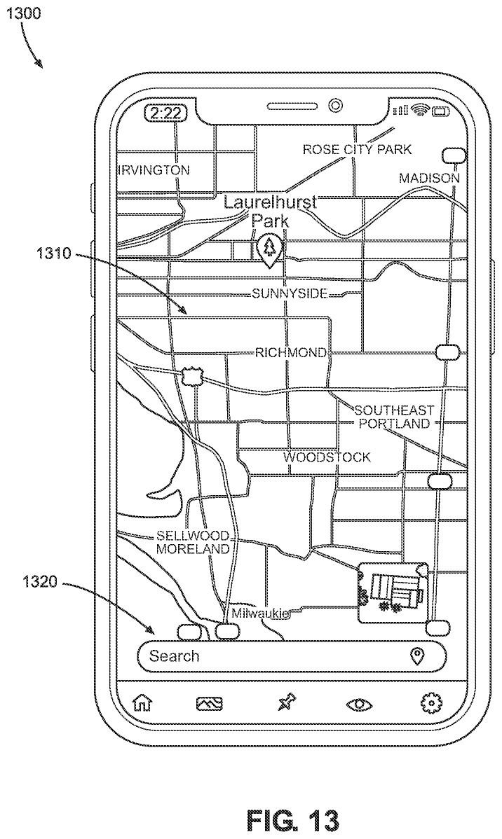

FIG. 13 illustrates a screenshot of a map photo 1300 of the system for augmented reality landscape planning 100, in accordance with one embodiment of the present invention.

The map photo 1300 may be a MapQuest or Google Maps map photo 1310 or the like and also includes a search box 1320 to locate desired venues on the map photo 1300.

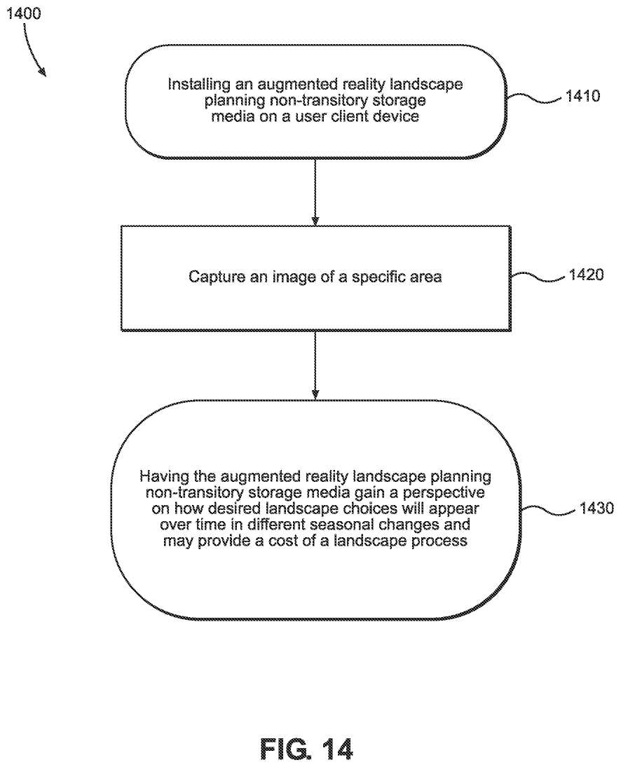

FIG. 14 illustrates a flowchart for a method for augmented reality landscape planning 1400, in accordance with one embodiment of the present invention.

The overall method 1400 may include the steps of installing an augmented reality landscape planning non-transitory storage media on a client device 1410, capturing an image of a specific area 1420, and having the augmented reality landscape planning non-transitory storage media gain a perspective on how their desired landscape choices will appear over time in different seasonal changes and may provide a cost analysis of a landscape process 1430.

The installing step 1410 may further comprise a plurality of augmented reality algorithms residing on an augmented reality landscape planning non-transitory storage media that superimpose a plurality of prospective landscape designs on the image of the specific area in order to visualize potential landscaping options in the specific area.

The capturing step 1420 may include capturing the image of the specific area is by a camera disposed within the client device. The capturing step 1420 may also include capturing the image of the specific area is from a satellite imagery from a Global Positioning System to provide an overhead view of the specific area.

The having step 1430 may include the augmented reality algorithms will further allow for the user to gain a perspective on how their desired landscape choices will appear over time in different seasonal changes.

References in the specification to “an exemplary embodiment”, “an embodiment”, “a preferred embodiment”, “an alternative embodiment” and similar phrases mean that a particular feature, structure, or characteristic described in connection with the embodiment(s) is included in at least an embodiment of the disclosure. The appearances of the phrase “a non-limiting exemplary embodiment” in various places in the specification are not necessarily all meant to refer to the same embodiment.

There has thus been outlined, rather broadly, the more important features of the disclosure in order that the detailed description thereof that follows may be better understood, and in order that the present contribution to the art may be better appreciated.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the disclosure of the application, nor is it intended to be limiting as to the scope of the disclosure in any way.

What is claimed is:

1. A system for augmented reality landscape planning, comprising:
a server system with a processor system, a communications interface, a communications system, an input system and an output system, the server system having access to a communications network;
a memory system with an operating system, a communications module, a web browser module, a web server application and an augmented reality landscape planning non-transitory storage media; and
a client device having a plurality of screenshots residing on the augmented reality landscape planning non-transitory storage media.

2. The system according to claim 1, wherein the client device will capture an image of a specific area in real time.

3. The system according to claim 2, wherein the captured image is captured by a camera disposed within the client device.

4. The system according to claim 2, wherein the captured image is captured by a satellite imagery from a Global Positioning System to provide an overhead view of the specific area.

5. The system according to claim 1, wherein the augmented reality algorithms will gain a perspective on how their desired landscape choices will appear over time in different seasonal changes.

6. The system according to claim 1, wherein the screenshots include a home page screenshot, a create an account page screenshot, a new subscriptions screenshot, a log-in screenshot, a settings screenshot, a plant and location data screenshot, an augmented reality screenshot, a designer screenshot, a cellphone camera photo screenshot, a GPS photo screenshot, and a map photo screenshot displayed on the client device.

7. The system according to claim 6, wherein the cellphone camera photo screenshot includes a 9-section grid, an auto focus scope, a digital camera icon, a horizontal directional grid, a plurality of digital photo indicia, and a photo activation button.

8. The system according to claim 6, wherein the GPS photo screenshot includes a base snapshot, a location and date stamp of when the GPS photo was taken, and an “-” indicia that is activated to delete the GPS photo corresponding to the respective GPS photo screenshot.

9. The system according to claim 7, wherein the augmented reality page screenshot includes an augmented reality background, a cross-hair, a year timeline, a plurality of seasons, a plurality of supplemental indicia, a plurality of augmented reality tools, and a plurality of type of plant fields.

10. The system according to claim 1, further comprising a plurality of augmented reality algorithms residing on an augmented reality landscape planning non-transitory storage media superimpose a plurality of prospective landscape designs on the image of the specific area in order to visualize potential landscaping options in the specific area.

11. A method for augmented reality landscape planning, comprising the steps of:
installing an augmented reality landscape planning non-transitory storage media on a client device;
capturing an image of a specific area; and
having the augmented reality landscape planning non-transitory storage media gain a perspective on how their desired landscape choices will appear over time in different seasonal changes;
further comprising a plurality of augmented reality algorithms residing on an augmented reality landscape planning non-transitory storage media that superimpose a plurality of prospective landscape designs on the image of the specific area in order to visualize potential landscaping options in the specific area.

12. The method for augmented reality landscape planning, according to claim 11, wherein the capturing the image of the specific area is by a camera disposed within the client device.

13. The method for augmented reality landscape planning, according to claim 11, wherein the capturing the image of the specific area is from a satellite imagery from a Global Positioning System to provide an overhead view of the specific area.

14. The method for augmented reality landscape planning, according to claim 11, wherein the augmented reality landscape planning non-transitory storage media provides a cost analysis of a landscape process.

15. The method for augmented reality landscape planning, according to claim 11, wherein the augmented reality algorithms will further allow for the user to gain a perspective on how their desired landscape choices will appear over time in different seasonal changes.

16. A non-transitory computer storage media having instructions stored thereon which, when executed, execute a method comprising the steps of:
installing an augmented reality landscape planning non-transitory storage media on a client device;
capturing an image of a specific area; and
having the augmented reality landscape planning non-transitory storage media gain a perspective on how their desired landscape choices will appear over time in different seasonal changes;
further comprising a plurality of augmented reality algorithms residing on an augmented reality landscape planning non-transitory storage media that superimpose a plurality of prospective landscape designs on the image of the specific area in order to visualize potential landscaping options in the specific area.

17. The non-transitory computer storage media, according to claim 16, wherein the capturing the image of the specific area is by a camera disposed within the client device.

18. The non-transitory computer storage media, according to claim 16, wherein the capturing the image of the specific area is from a satellite imagery from a Global Positioning System to provide an overhead view of the specific area.

19. The non-transitory computer storage media, according to claim 16, wherein the augmented reality landscape planning non-transitory storage media provides a cost analysis of a landscape process.

20. The non-transitory computer storage media, according to claim 16, wherein the augmented reality algorithms will further allow for the user to gain a perspective on how their desired landscape choices will appear over time in different seasonal changes.
